(19) United States
(12) Patent Application Publication
(10) Pub. No.: US 2016/0162817 A1
(43) Pub. Date: Jun. 9, 2016

(54) Vehicle Reconditioning Workflow System

(71) Applicant: Green Cloud Process, LLC, Jacksonville, FL (US)

(72) Inventors: Douglas Grimaldi, Jacksonville, FL (US); Bradley Schafer, Jacksonville, FL (US)

(73) Assignee: GREEN CLOUD PROCESS, LLC, Jacksonville, FL (US)

(21) Appl. No.: 14/563,998

(22) Filed: Dec. 8, 2014

(51) Int. Cl. G06Q 10/06; G06Q 10/00

(52) U.S. Cl. CPC G06Q 10/0633; G06Q 10/20

(57) ABSTRACT

Systems, methods, and computer program products for facilitating an online task management system portal that enables vehicle managers and vehicle service providers to track, monitor, update, and communicate vehicle status information in substantially real-time during a generated vehicle reconditioning process are disclosed. In an aspect, such online system allows users to identify what work needs to be done on a given vehicle and have a workflow order generated therefore in order to make the vehicle suitable for resale. The cost associated with that work may also be easily tracked and identified. Furthermore, the work and cost information may be updatable and seamlessly viewable by all system users in order to enhance the efficiency of the vehicle reconditioning process.

### FIELD OF THE DISCLOSURE

The present disclosure generally relates to vehicle reconditioning and more particularly to mechanisms usable by entities for managing the reconditioning process for a vehicle.

### BACKGROUND

The statements in this section merely provide background information related to the present disclosure and may not constitute prior art.

The average car on the road is approximately 10 years old. With ever-increasing improvements in modern technology and vehicle designs, the useful life of any given vehicle is significant. Due to these improvements, consumers often times want to purchase a new vehicle while their old vehicle still has a significant amount of useful life remaining. This creates a large market for used vehicles that many car dealerships and similar entities are eager to take part in. Particularly over the past 15-20 years, this market has reached a notable size.

A commonly known problem faced by any vehicle owners is that vehicles essentially depreciate in value every day. This problem causes particular frustration to dealerships who may wish to buy and sell used vehicles in that a purchased used vehicle almost always must be reconditioned by the dealership by at least some degree before it is sold in order to maximize its sales value. The reconditioning process, on average, takes 7-10 days and involves around 7-10 departments at the dealership and/or external service vendors. During that time period, the purchased vehicle continues to decrease in value, and therefore the estimated sale price of the car calculated by a sales manager on the day it was purchased by the dealership may be higher than what it is on the day the car is actually offered for sale, resulting in the dealership obtaining a lower profit on the sale of the vehicle than expected. Additionally, vehicles that leave the dealership for reconditioning services may be difficult to keep track of.

Attempts have been made to try to increase the speed of the reconditioning process. Systems have been designed to monitor vehicle reconditioning and make the process faster; however, these systems are not well liked in the industry because they are difficult to understand, unnecessarily complex in use, do not include every aspect of the reconditioning process, are not well suited for professional use, and/or do not keep a vehicle accessible by the system during the entire reconditioning process.

Given the foregoing, what is needed are systems, methods, and computer program products which facilitate the efficient management of the vehicle reconditioning process at a dealership or similar entity. Additionally, systems, methods, and computer program products are desired that are easy to use and understand, are comprehensive of the entire reconditioning process, are professional in functionality, and serve to increase the rate of the reconditioning process.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure meet the above-identified needs by providing systems, methods, and computer program products which facilitate the ability of a dealership or other entity to generate and manage a reconditioning process for a purchased vehicle that is to be resold. Specifically, computer devices and systems are used to receive data input regarding the current status of a vehicle at given stages in the reconditioning process depending on which department/vendor currently has possession of the vehicle, receive instructions and determine an optimal workflow order regarding how to recondition the vehicle, and/or facilitate payments regarding reconditioning services performed. The received data can be used to monitor and track the work being done on the vehicle to ensure that it is moving through the reconditioning process as efficiently as possible. Any unnecessary delays in the process can be easily and quickly identified; and, more importantly, remedied, thereby decreasing the time a vehicle spends being reconditioned and moving the date forward at which it may be offered for sale, thereby increasing the profit that may be made on the vehicle.

In an aspect, a vehicle identification number (VIN) barcode is scanned using a mobile application and a 17-character string is recorded into a system in order to create a unique identifier for the associated vehicle. This unique identifier may allow users to monitor the status of the vehicle as it moves amongst the various departments/vendors involved in the reconditioning process. By way of example and not limitation, the current jobs being performed on the vehicle, the employees assigned to perform those jobs, and the time those jobs are taking/will take may all be tracked, monitored, and viewed via the system. By monitoring and tracking the entire reconditioning process, managers may be able to place more accountability on particular departments/vendors and/or individual employees, as well as offer performance-based incentives.

In an aspect, every entity involved in the reconditioning process may have its own log-in credentials for the system in order to view, monitor, track, and input information, especially as related to the particular entity's duties regarding the reconditioning process. By way of example and not limitation, entities may include dealerships, dealership departments, vendors, and any employees associated therewith.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for facilitating the management of workflow relating to a vehicle reconditioning process, according to an aspect of the present disclosure.

FIG. 2 is a flowchart illustrating an exemplary reconditioning process of a vehicle managed using the system of FIG. 1, according to an aspect of the present disclosure.

FIG. 3 is a flowchart illustrating a second exemplary reconditioning process of a vehicle managed using the system of FIG. 1, according to an aspect of the present disclosure.

FIG. 4 is a pair of exemplary screenshots which may display on a computing device to initiate a process for reconditioning a vehicle managed using the system of FIG. 1, according to an aspect of the present disclosure.

FIGS. 5A-5F are screenshots which collectively illustrate exemplary processes, systems, and computer program products for managing a vehicle reconditioning process using at least one computing device.

FIGS. 6A-6N are screenshots which collectively illustrate additional exemplary processes, systems, and computer program products for managing a vehicle reconditioning process using at least one computing device.

FIG. 7 is a block diagram of an exemplary computing system useful for implementing aspects of the present disclosure.

### DETAILED DESCRIPTION

The present disclosure is directed to systems, methods, and computer program products that facilitate the management of a vehicle reconditioning process. Specifically, aspects of the present disclosure provide systems, methods, and computer program products that allow an entity, such as a car dealership, to direct, generate, track, and monitor the reconditioning process of a purchased vehicle that is to be resold. Such directing, tracking, and monitoring may allow an employee of the entity, such as a manager, to input instructions for reconditioning a vehicle, have an optimal workflow order generated for reconditioning the vehicle, and/or identify the status of the vehicle in substantially or near real-time. The vehicle status may include which department/vendor is currently in possession of the vehicle, what work is currently being done/scheduled to be done on the vehicle, timetables regarding the work to be done on the vehicle, and other similar information.

The terms “recondition/reconditioning” are used throughout herein to refer to any process or task that may be performed on a vehicle in order to improve its appearance and/or functionality in order to increase its value and desirability at sale. By way of example and not limitation, reconditioning may include painting, cleaning, upgrading, and/or repairing a vehicle or any component thereof.

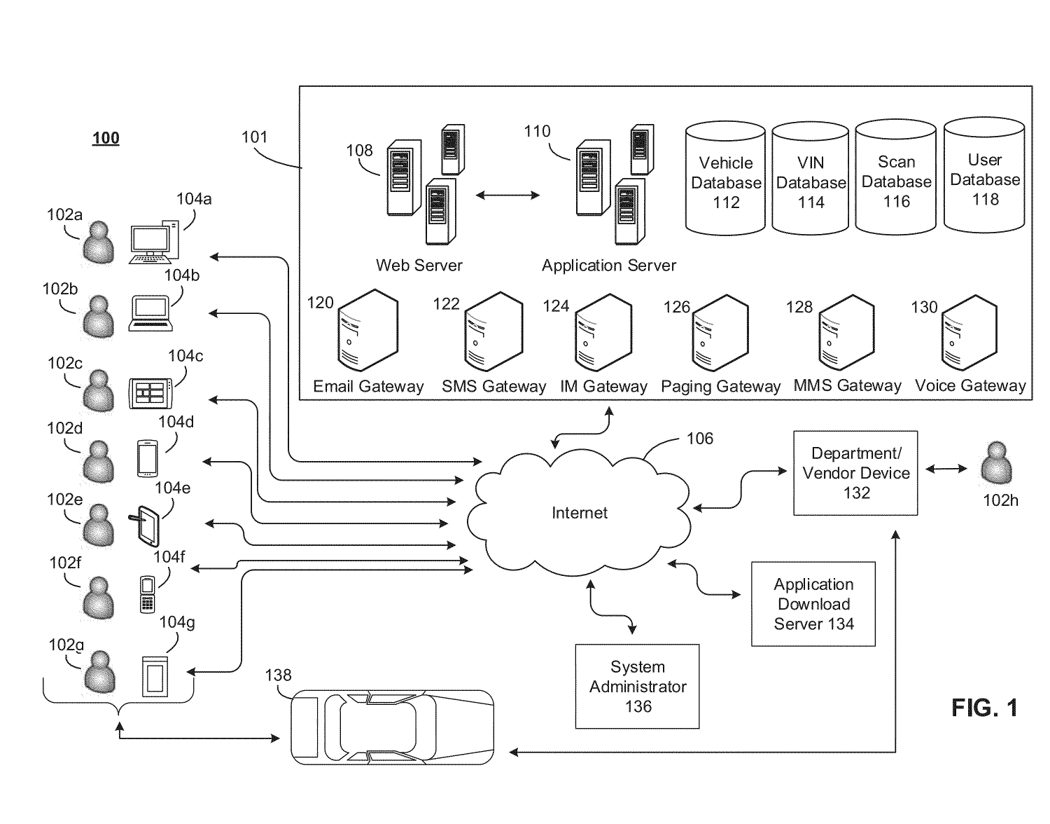

Referring now to FIG. 1, a block diagram of an exemplary system 100 for facilitating the management of workflow relating to a vehicle reconditioning process, according to an aspect of the present disclosure, is shown.

Cloud-based, Internet-enabled device communication system 100 includes a plurality of users 102 (shown as users 102a-g in FIG. 1) accessing—via a computing device 104 (shown as respective computing devices 106a-g in FIG. 1) and a network 106, such as the global, public Internet—an application service provider's cloud-based, Internet-enabled infrastructure 101. In some aspects, a user application may be downloaded onto user computing device 104 from application download server 134 via network 106. In other aspects, infrastructure 101 may be accessed via a website or web application.

User 102 may access infrastructure 101 in order to input information about one or more vehicles 138, assign/view task details to be performed on vehicle 138, view/update the status of vehicle 138, and the like. Generally, user 102 may comprise two broad groups: managing users 102 and service providing users 102. Managing users 102 may include vehicle 138 owners, dealership managers, used car managers, account owners within system 100, reconditioning managers, service vendor managers, and other users of significant decision-making authority as may become apparent to those skilled in the relevant art(s) after reading the description herein. Likewise, service providing users 102 may include technicians, department/vendor employees, and other similar users 102 as may become apparent to those skilled in the relevant art(s) after reading the description herein. Generally, vehicle 138 will be a used vehicle that is desired to be resold for a profit. Service vendors may include any entity that performs reconditioning work on vehicle 138.

In various aspects, computing device 104 may be configured as: a desktop computer 104a or 104e; a laptop computer 104b or 104f; a Personal Digital Assistant (PDA) or mobile telephone (alternatively referred to as a mobile device) 104c or 104g; a tablet or mobile computer 104d or 104h; any commercially-available intelligent communications device; or the like. Such computing devices may comprise sensors such as a camera, a CCD, near-field communications transceiver, Bluetooth® chip (a wireless technology standard standardized as IEEE 802.15.1), a GPS sensor, and the like. Such sensors may be configured to detect the environmental elements, physical assets, and the like.

In some aspects, a user 102h may use a department/vendor device 132 to access infrastructure 101 and/or gather data from vehicle 138. Department/vendor device 132 may by a standalone computing device substantially similar to computing device 104 that stays within and is designated for use with a specified department/vendor. As department/vendor device 132 comprises substantially the same functional features as computing device 104, any discussion below regarding computing device 104 will also be understood to include department/vendor device 132, without restating such inclusion every time, for clarity. Each computing device 104 and department/vendor device 132 may include a scanner for scanning the VIN barcode of vehicle 132.

Computing device 104 and/or department/vendor device 132 may comprise a user interface via which user 102 may interact with system 100. The user interface may comprise a display screen, a keyboard, a mouse, a joystick, a touch screen, multi-finger controls, or any other similar interfacing mechanisms as recognized by those skilled in the relevant art(s), as well as any combination thereof.

An application service provider's cloud-based, communications infrastructure 101 may include one or more web servers 108, one or more application servers 110, a vehicle database 112, a VIN database 114, a scan database 116, a user database 118, an email gateway 120, an SMS gateway 122, an Instant Message (IM) gateway 124, a paging gateway 126, an MMS gateway 128, and a voice gateway 130. In various aspects, one or more of vehicle database 112, VIN database 114, scan database 116, and user database 118 are omitted and/or combined. In some aspects, one or more such databases is supplied by a third-party.

Vehicle database 112 contains information about vehicles 138 that have been input or otherwise interacted with by users 102. Among other ways, users 102 may scan a vehicle VIN number, or otherwise acquire the vehicle VIN number (e.g., reading it off a plate on vehicle 138, receiving it via wired or wireless communication with vehicle 138 or a third-party, and the like). Vehicle database 112 may contain user-provided images, descriptions, statuses, cost estimates, progress reports, and the like regarding vehicle 138. A specific vehicle 138 may be searchable within vehicle database 112 by user 102 utilizing the user interface integrated with computing device 104.

VIN database 114 contains information allowing infrastructure 101 to decode received VINs to identify the make, model, year, and features of vehicle 138.

Scan database 116 contains the scans made by users 102 and/or information related to the scans such as geographic location, time of scan, number of scans taken before and after a given scan, and the like.

User database 118 contains information about each user 102 of system 100 including but not limited to type of computing device 104 utilized, location of user 102, username and password, department/vendor associated with, employment status, indications of scan history, dealership associated with, projects completed, assigned projects, and/or the like.

In some aspects, a system administrator 136 may access infrastructure 101 via network 106 in order to oversee and manage infrastructure 101. Additionally, user permissions regarding each feature of system 100 may be adjustable to allow varying degrees of user 102 interaction and viewability of the different aspects of system 100 depending on the type of user 102 involved. By way of example and not limitation, a managing user 102 may have permission to access more features and/or make more changes within system 100 than a service providing user 102.

In alternate aspects, vehicle database 112, VIN database 114, scan database 116, or user database 118 may comprise one or more data stores within (or remotely located from) infrastructure 101 or be a memory included in (or coupled to) web server 108.

Vehicle database 112, VIN database 114, scan database 116, and user database 118 may each be physically separate from one another, logically separate, or physically or logically indistinguishable from some or all other databases.

Different systems 100 for different entities may communicate and/or be integrated with each other for seamless digital interaction among the entities' users 102.

As will be appreciated by those skilled in the relevant art(s) after reading the description herein, in such an aspect, an application service provider—an individual person, business, or other entity—may allow access, on a free registration, paid subscriber and/or pay-per-use basis, to infrastructure 101 via one or more World-Wide Web (WWW) sites on the Internet 106. Thus, system 100 is scalable.

As will also be appreciated by those skilled in the relevant art(s), in an aspect, various screens would be generated by server 108 in response to input from users 102 over Internet 106. That is, in such an aspect, server 110 is a typical web server running a server application at a website which sends out webpages in response to Hypertext Transfer Protocol (HTTP) or Hypertext Transfer Protocol Secured (HTTPS) requests from remote browsers on various computing devices 104 being used by various users 102. Thus, server 108 is able to provide a graphical user interface (GUI) to users 102 of system 100 in the form of webpages. These webpages are sent to the user's PC, laptop, mobile device, PDA or like device 104, and would result in the GUI being displayed.

As will be appreciated by those skilled in the relevant art(s) after reading the description herein, alternate aspects of the present disclosure may include providing a tool for facilitating content sharing coupled with a producer-designated physical asset to devices 104 as a stand-alone system (e.g., installed on one server PC) or as an enterprise system wherein all the components of infrastructure 100 are connected and communicate via an inter-corporate Wide Area Network (WAN) or Local Area Network (LAN). For example, in an aspect where users 102 are all personnel/employees of the same company, the present disclosure may be implemented as a stand-alone system, rather than as a web service (i.e., Application Service Provider (ASP) model utilized by various unassociated/unaffiliated users) as shown in FIG. 1.

As will also be appreciated by those skilled in the relevant art(s) after reading the description herein, alternate aspects of the present disclosure may include providing the tools for facilitating content sharing coupled with a producer-designated physical asset via infrastructure 101 and devices 104 via a browser or operating system pre-installed with an application or a browser or operating system with a separately downloaded application on such devices 104. That is, as will also be apparent to one skilled in the relevant art(s) after reading the description herein, the application that facilitates the content sharing platform herein, may be part of the “standard” browser or operating system that ships with computing device 106 or may be later added to an existing browser or operating system as part of an “add-on,” “plug-in,” or “app store download.”

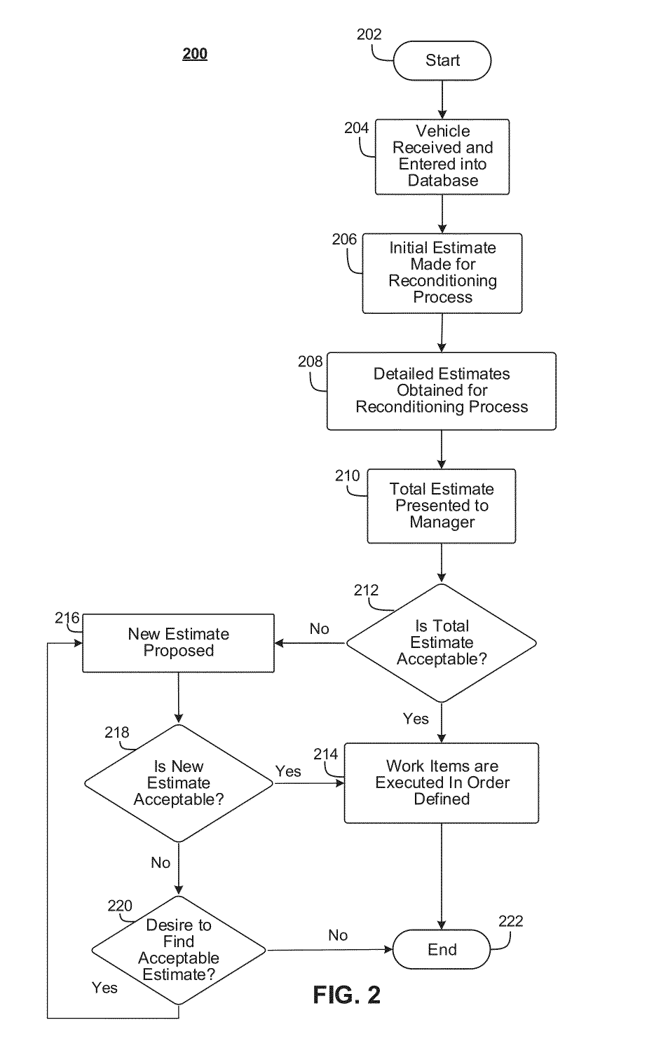

Referring now to FIG. 2, a flowchart illustrating an exemplary reconditioning process 200 of a vehicle 138 managed using system 100, according to an aspect of the present disclosure, is shown.

Process 200, which may execute within system 100, beings at step 202 with control passing immediately to step 204.

At step 204, a vehicle 138 is received by an entity, such as, by way of example and not limitation, a car dealership or a service vendor, and is entered into vehicle database 112 to prepare it for use within system 100, which may be configured to interface with a dealer management system (DMS) or similar vehicle tracking portal. Vehicle 138 may be entered manually, such as by typing relevant information about the vehicle, including the VIN number, into computing device 104 communicating with a website provided by system 100. Alternatively, vehicle 138 may be entered via a scanning process, such as by scanning the VIN number using a mobile device sensor, such as a camera, a CCD, a near-field communications transceiver, a Bluetooth® chip (a wireless technology standardized as IEEE 802.15.1), and the like. In some aspects, the vehicle VIN number may be detected or otherwise received from vehicle 138 via a variety of techniques using one or more of: near-field communications, radio transmissions, Bluetooth® communications, RFID protocols, and the like. Any other methods of entering vehicle 138 into system 100 may be utilized as may become apparent to those skilled in the relevant art(s) after reading the description herein.

Once vehicle 138 has been entered into system 100, its current physical location may be represented visually on a graphic displayed on the user interface of computing device 104. The graphic may be brought up by pressing a link labeled, by way of example and not limitation, “locate vehicle” within the user interface. By way of example and not limitation, a map of an entity's vehicle sales lot may be displayed, with a symbol indicating the location of vehicle 138 on the lot. By way of example and not limitation, the location of vehicle 138 may be determined via integrated RF tags and electronic fences that communicate with system 100, or by any other similar means as may become apparent to those skilled in the relevant art(s) after reading the description herein. In some aspects, a photo of vehicle 138 is used to represent its current location. In some additional aspects, multiple photos may be uploaded and then displayed upon request that show various images of vehicle 138, including any damage/defects that need to be repaired before it is sold. Such images may be captured by one or more cameras integrated with computing device 104 at the time vehicle 138 is received by system 100. In some further aspects, the map may allow for user 102 interaction such that a user may digitally move the symbol for vehicle 138 to a different location and thereby direct where it should go next within process 200.

Also during step 204, an initial inspection may be made on vehicle 138 by user 102 in order to determine various services that may need to be performed on vehicle 138. The services may comprise a workflow for reconditioning process 200 and may be selected, input, and stored with vehicle 138 information within vehicle database 112. By way of example and not limitation, desired services may include painting, detailing, dent repair, and the like. The workflow of services may be entered, altered, and manipulated, such as by manipulating graphic images displayed on the user interface within computing device 104, or by entering/manipulating text, selecting various check boxes/radio buttons, or via any other means as may be apparent to those skilled in the relevant art(s) after reading the description herein. In some aspects, the selected services comprising the desired workflow for vehicle 138 may be ordered and/or directed autonomously by the hardware and software of system 100 actively or passively after process 200 has been initiated. Specifically, system 100 may use previously determined guidelines to determine an optimal order in which the desired services should be performed, direct where vehicle 138 should go once the previous service has been completed (e.g., which department/vendor), determine what service vehicle 138 should receive at any given point during process 200, and track the progress of vehicle 138 completely or partially automatically, without any significant additional input from user 102, thereby keeping the workflow of process 200 moving efficiently without delay periods in which approval from user 102 is pending. In such aspects, system 100 may send notifications to one or more users 102 with information regarding status updates for vehicle 138 upon request of such notifications. Notifications may be requested for certain time intervals (e.g., every 2 hours), upon the completion of every task, or based on other settings as will become apparent to those skilled in the relevant art(s) after reading the description herein. In other aspects, user 102 must approve and/or direct each service associated with the given workflow as it is completed.

System 100 may be pre-programmed with a set of various guidelines/parameters that allow it to determine an optimal workflow order for the services to be performed on vehicle 138 during reconditioning process 200. By way of example and not limitation, system 100 may be programmed to always place any cleaning services at or near the end of process 200 so that a cleaned vehicle 138 is not made dirty during the performance of other services. Based on inputs from users 102, system 100 may determine what service vehicle 138 should receive next, whether a service should be repeated or skipped, if process 200 is complete for vehicle 138, and similar determinations as may become apparent to those skilled in the relevant art(s) reading the description herein.

In some aspects, default services and/or an order for performing them as part of a standard reconditioning process 200 template may be generated by system 100 and presented to one or more managing users 102 for approval after an initial inspection has been made on vehicle 138. As different users 102 have differing preferences regarding the reconditioning of vehicles 138, the template may be customizable and adjustable for each user, especially for each major entity that uses system 100, such as dealerships and the like. The template may be selectively followed at any point during reconditioning process 200, and may or may not be followed immediately or consistently. In aspects wherein reconditioning process 200 proceeds partially or completely without a template, services and/or the order in which they are performed may be determined by user 102.

In some aspects, a managing user 102 may assign a service to be performed on vehicle 138 to one or more specific service providing users 102 within one or more departments/vendors. In other aspects, service providing users 102 may assign themselves to specific services. In instances where outside vendors are used to complete a service, a digital vendor marketplace may be integrated within system 100 that includes a list of approved vendors by the entity that managing user 102 is associated with, as well as the availability of the vendors. Specific vendors may be selected from the vendor marketplace to perform given services. Alternatively, managing user 102 may allow the first vendor to sign up to complete a service to get the job and/or give the job to the vendor that proposes to do it for the lowest cost.

At step 206, an initial estimate is made representing the total expected cost of reconditioning process 200 for vehicle 138 and the desired services to be performed. The estimate may be determined by a used car manager and/or reconditioning manager acting as managing user 102 associated with the entity that received vehicle 138. The selected services input at step 204 may be added to/modified/deleted and cost estimates may be determined for each service. The cost estimates determined by the managing user 102 may be cumulated and selectable within an “outbox” that may be visible and accessible within system 100 by a variety of departments/vendors that may be interested in performing the desired services.

At step 208, detailed estimates are obtained for reconditioning process 200. Specifically, various vendors/departments view the list of services desired to be performed on vehicle 138 as determined by managing user 102 as displayed in an ‘inbox” via the user interface on computing device 104 within system 100. The vendors/departments then submit specific estimates for how much they will charge to complete the services that they are willing/able to perform. In some aspects, step 208 is not performed. The time taken to complete the detailed estimates may be tracked by system 100 for the purpose of tracking the performance of those users 102 generating the estimates.

At step 210, the specific estimates are submitted to one or more managing users 102 for review and/or approval. The estimates may be viewable in the form of an “inbox” viewable by managing user 102. Managing user 102 may base such approval on the total cost estimated to complete reconditioning process 200 for vehicle 138 as compared to the total amount expected to be received upon sale of vehicle 138. When multiple managing users 102 for approval, final approval authority may reside in a top-level managing user 102, an select group of managing users 102, a majority of managing users 102, or by any other arrangement as may be apparent to those skilled in the relevant art(s) after reading the description herein. In aspects wherein step 208 is not performed, step 210 may not be performed.

At step 212, it is determined whether the total estimate for reconditioning vehicle 138 is acceptable. Specifically, managing user 102 may determine whether the submitted estimates are reasonable for the work to be performed, if the cost of reconditioning vehicle 138 will allow for a reasonable profit to be made on vehicle 138 upon sale, and similar factors as may be recognized by those skilled in the relevant art(s). The determination may be made based on reconditioning process 200 as a whole or on each desired service individually, or on various groups of services, such as by way of example and not limitation, a group of services to be provided by a common department/vendor. The determination may be made by input into system 100 via computing device 104. In some aspects, system 100 makes the determination based on factors pre-programmed into system 100, such as formulas that determine the profit to be made on vehicle 138 based on a current market value of vehicle 138 updateable in substantially real-time and the current projected cost of reconditioning process 200 and compare the determined profit to a baseline desired profit. By way of example and not limitation, system 100 may access information from an internal database and/or third-party website or database to determine that a particular vehicle 138 may currently sell for $20,000. Based on information received from one or more users 102, system 100 may further determine that reconditioning process 200 will cost $500 and that vehicle 138 was bought by the entity associated with user 102 for $18,000. System 100 would then determine that a profit of $1,500 may be made upon the sale of vehicle 138 and therefore the estimate for reconditioning process 200 may be approved if system 100 is pre-programmed to make sure a profit of at least $500 is made on any vehicle 138. If users 102 adjust costs and/or vehicle 138 depreciates during process 200, system 100 (or a managing user 102) may send a cancel notification to users 102 that process 200 should cease if the projected profit drops below the pre-established threshold. If determination step 212 is positive, process 200 proceeds to step 214. If the determination is negative, process 200 proceeds to step 216.

At step 214, approved service(s) is/are executed based on a defined order that may be configured in the original request for services at step 204. By way of example and not limitation, an order of services to be performed as part of a comprehensive reconditioning process 200 may indicate that vehicle 138 must first have dents repaired, must then be painted, and finally must be cleaned.

When a given service has been completed on vehicle 138, the department/vendor responsible for completing such service may mark the service as so completed within system 100 by using the user interface provided by computing device 104. A list of recently completed vehicles 138 for that particular department/vendor may be generated by system 100 and be viewable by users 102. Any vehicle 138 that has been worked on by a given department/vendor may be tagged as such within system 100 and may be searched for within vehicle database 112 based on having been worked on by that department/vendor. Additionally, before a given service has been completed/started, the cost estimate for the service may be adjusted in substantially real-time as aspects of the service change. By way of example and not limitation, in an instance wherein the hood of vehicle 138 contains a dent, the cost of repairing the dent may increase as service providing user 102 discovers that the entire hood must be replaced instead of simply “popping” the dent out. In response to such changes in cost, or for any other reasons, individuals with proper authority may log into system 100 and cancel/chance service providing users 102 for any services for vehicle 138 that have not been completed yet; likewise, the entire reconditioning process 200 may be canceled if it is determined that vehicle 138 will no longer produce a desired profit upon resale.

In some aspects, the user interface of computing device 104 may provide a graphical overview to users 102 who log in to system 100 to check the status of vehicle 138. The graphical overview may show the list of services that have been requested for vehicle 138, which services have been completed, which services are currently being performed, which department/vendor currently has possession of vehicle 138, and any similar information as may become apparent to those skilled in the relevant art(s) after reading the description herein. Likewise, the length of time vehicle 138 has spent in the workflow of services may be displayed, as well as how long each completed service has taken, how long the currently performed service is taking, and approximately how long the remaining services will take, either individually or as a whole.

In some aspects, system 100 is capable of tracking the time vehicle 138 has spent in the workflow of services as early as when the initial appraisal of vehicle 138 begins, but before any ownership transfer has occurred. This day of initial appraisal may be identified as an “inventory date” within system 100 and may provide for precise time tracking that allows for the possibility of more efficient management of reconditioning process 200 and therefore minimizes depreciation of vehicle 138. In some further aspects, system 100 is capable of tracking the time of reconditioning process 200 when an entity actually takes ownership of vehicle 138, thereby adding another form of precision to the time management of reconditioning process 200.

In such aspects wherein system 100 begins tracking the workflow time of vehicle 138 upon the initial appraisal thereof, such time may be stored as a “book time” value. By viewing the book time associated with vehicle 138, users 102 may be motivated to take faster action on vehicle 138 if it is noticed that it has spent a significant amount of time within/waiting to be approved for reconditioning process 200. Additionally, a depreciation amount may be displayed that is associated with the book time. More specifically, because vehicle 138 may lose value every day, such drops in value may be tracked/recorded/calculated and displayed in conjunction with the book time value in order to indicate to users 102 how much money is being lost on vehicle 138 as time goes by, thereby helping to ensure maximum productivity on projects pertaining to vehicle 138 via financially incentivizing motivation. The depreciation amount may be calculated by/within system 100 by comparing the Black Book® value, the Milhein auction value, or any similar valuation for vehicle 138 as will be appreciated by those skilled in the relevant art(s) after reading the description herein, between a current value and a value attributable to a previous time, such as the book time or inventory date. The values and their associated dates/times may be retrievable on demand from system 100 by any user 102 in order, by way of example and not limitation, to make strategic decisions regarding reconditioning process 200, including canceling process 200 for a given vehicle 138, if, for example, it is determined that it will no longer be profitable. By way of example and not limitation, relevant valuation information may be obtained from an inventory feed list that stores and displays information for every vehicle 138 within possession of a given dealership/department/vendor within system 100, including make, model, year, and the like. A key time period to check for depreciation may be between the inventory date and when reconditioning process 200 was created for a given vehicle 138. This time period may be evidence of a work flow efficiency problem, and can quantify the problem in terms of profits lost on vehicle 138 due to the accumulated depreciation.

Service providing users 102 may use the user interface provided by system 100 on computing device 104 to view all of vehicles 138 that have been assigned to them, as well as the status of those vehicles 138, what services they are required to perform on such vehicles 138, how much time they are granted to perform such services, as well as any similar information as may be apparent to those skilled in the relevant art(s) after reading the description herein.

The user interface presented by computing device 104 to service providing users 102 may display the list of services to be performed on vehicle 138 by a particular service providing user 102 in the form of an inbox. As service providing users 102 complete their services, the services are moved from the inbox to an outbox. Furthermore, the time of completion of the service is recorded for later viewing by, by way of example and not limitation, a managing user 102. In some aspects, a completed service remains in a service providing user 102's inbox and displays as “crossed-out” for a temporary period. Additionally, notifications of completed services are sent via system 100 to a managing user 102 in the form of, by way of example and not limitation, an email or SMS message viewable on computing device 104. Upon receipt of a completed service notification, a managing user 102 may complete payment for the service such as by entering a purchase order number or other similar payment means as recognized by those skilled in the relevant art(s). A purchase order notification may be sent via system 100 to computing device 104 of the service providing users 102 awaiting payment. Additionally, service providing users 102 may have the ability to view reports within system 100 via computing device 104 that show all outstanding invoices generated by managing users 102 and/or automatically by system 100, and/or purchase orders organized in a desired way, such as by date, amount, and the like. Likewise, dealerships and other entities may be able to integrate accounting functions with system 100 by viewing all invoices and purchase orders and by generating reporting and data exchange files related thereto.

Service providing users 102 may further elect to receive notifications regarding any vehicle 138 that has been assigned to them at specified time intervals, or in substantially real-time. Notifications may be sent to specific service providing users 102 or to entire departments/vendors. By way of example and not limitation, a service providing user 102 for a vendor responsible for vehicle detailing may receive a real-time email notification readable on computing device 104 that an assigned vehicle 138 has just left the body shop and will arrive for cleaning in 20 minutes.

In some aspects, managing users 102 may elect to have viewable timesheets that track the amount of time a service providing user 102 has taken to complete a given service and compare that time with a previously established estimated time for completing the service and/or with a standardized/average time for completing that service. In such aspects, managing users 102 may compensate service providing users 102 based on performance. In some additional aspects, the timesheets may be based on data obtained when a service providing user 102 “clocks in” and “clocks out” of a job via computing device 104.

At step 216, a managing user 102 proposes a counter-estimate to the department/vendor whose detailed estimate was not approved. The counter-estimate may comprise an adjusted cost and/or service that managing user 102 is willing to pay/have performed on vehicle 138. A list of pending counter-estimates may be viewable by managing user 102. Any estimate may be overridden or canceled by any user 102 with the appropriate permission authority.

At step 218, the department/vendor determines if the counter-estimate is acceptable, based largely on costs that will be incurred by the department/vendor in completing the service, such as labor, materials, and the like. In some aspects, system 100 determines if the counter-estimate is acceptable based on pre-programmed factors and settings, such as, by way of example and not limitation, at least 6% of the cost payable to a vendor must be profit. If the determination is positive, process 200 proceeds to step 214. If the determination is negative, process 200 proceeds to step 220.

At step 220, it is determined if negotiations should continue between managing user 102 and the department/vendor in order to find a mutually acceptable price at which to complete the requested service. Such a determination may be time-sensitive; that is, the longer it takes to agree on a price, the more vehicle 138 depreciates and the smaller the profit that may be made on vehicle 138, if any. In some aspects, system 100 may aid in this determination process by performing desired functions and presenting one or more determination-aiding factors, such as how much vehicle 138 has depreciated since reconditioning process 200 started. If the determination is positive, process 200 proceeds to step 216. If the determination is negative, process 200 proceeds to step 222.

Process 200 is terminated by step 222 and process 200 ends.

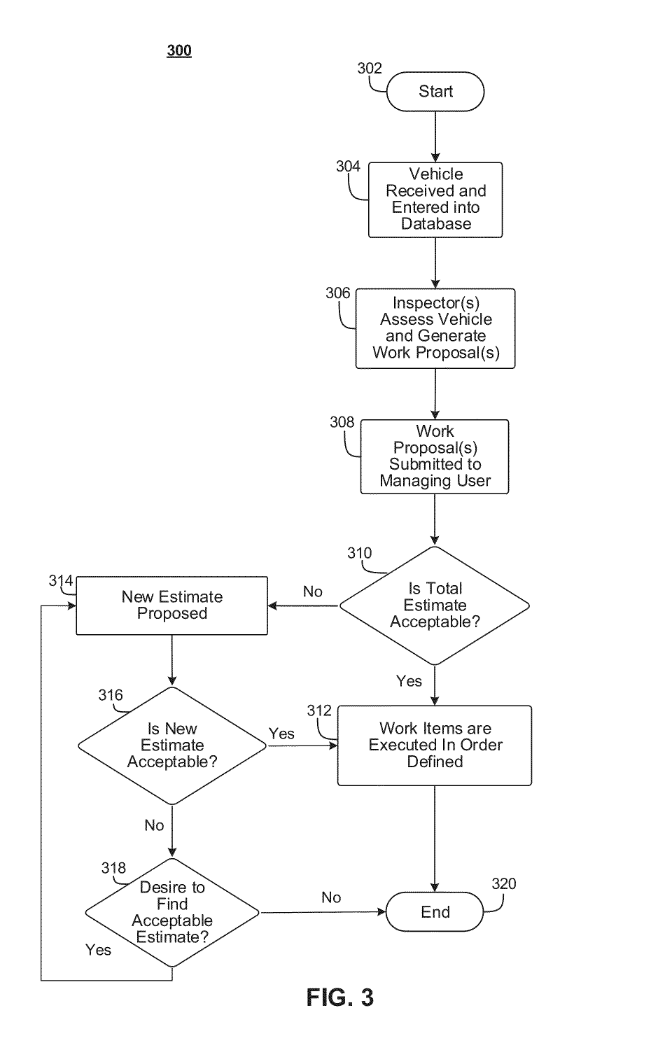

Referring now to FIG. 3, a flowchart illustrating a second exemplary reconditioning process 300 of a vehicle 138 managed using system 100, according to an aspect of the present disclosure, is shown.

Process 300, which may execute within system 100, beings at step 302 with control passing immediately to step 304.

At step 304, vehicle 138 is received by an entity and is entered into vehicle database 112 as in step 204 of process 200.

At step 306, vehicle 138 is assessed by one or more inspecting users 102 associated with one or more departments/vendors associated with system 100. Each inspecting user 102 may determine a list of one or more services to be performed by the associated department/vendor that are believed to be needed/desired in order to place vehicle 138 in a better condition for resale, in order to obtain a maximum profit thereon. Each inspecting user 102 may generate a work proposal on behalf of the department/vendor, such proposal setting forth a list of services and parts required to complete the work, as well as any costs associated with completing the work, including but not limited to, labor costs (including time), parts/materials costs, and the like.

At step 308, every complete work proposal is submitted to a managing user 102 for review and/or approval. In some aspects, a plurality of managing users 102 may review the work proposals, in which case the authority to make a final approval may reside within a single top-level managing user 102, a select group of managing users 102, a majority of managing users 102, or any other arrangement as may be apparent to those skilled in the relevant art(s) after reading the description herein. Step 308 is substantially similar to step 210 in process 200.

At step 310, it is determined whether a total cost estimate for reconditioning process 200 is acceptable, the total cost estimate being based on the submitted work proposals. Step 310 is otherwise substantially similar to step 212 of process 200. The remainder of process 300; namely, steps 312-320, are executed in the same way as steps 214-222 in process 200.

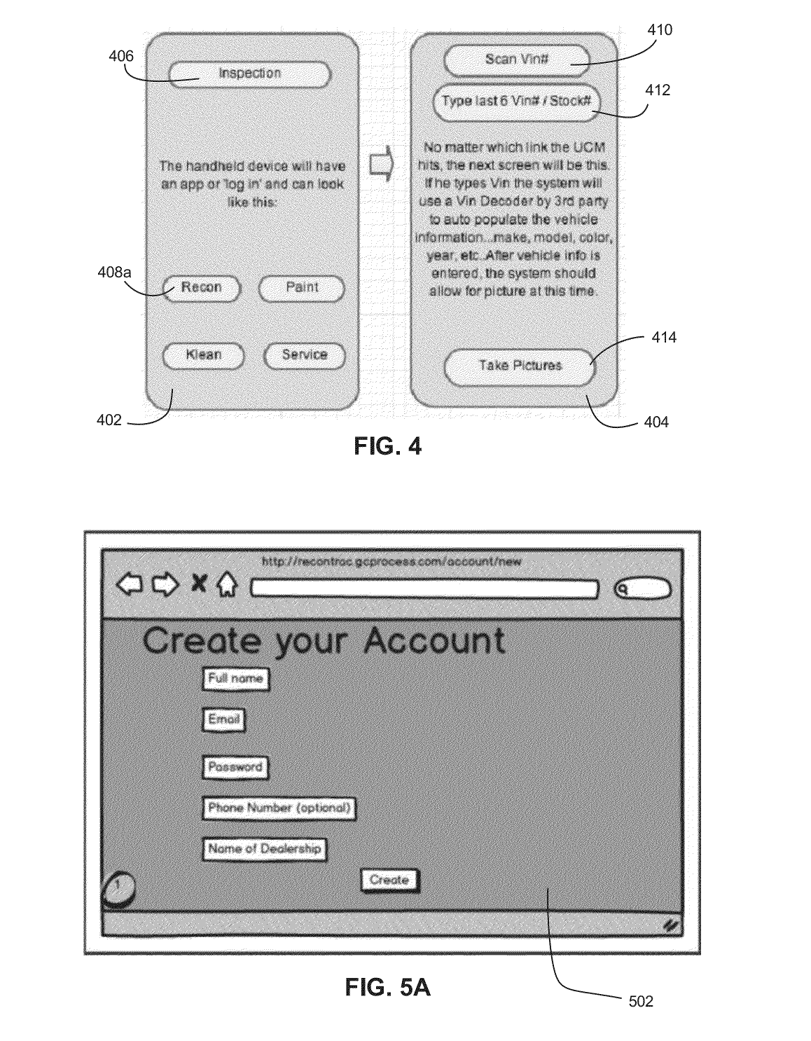

Referring now to FIG. 4, a pair of exemplary screenshots which may display on computing device 104 to initiate process 200 for reconditioning a vehicle managed using system of 100, according to an aspect of the present disclosure, are shown.

Screen 402 may be presented to user 102, particularly a managing user 102, before or during step 204. Screen 402 may give user 102 the option to create an inspection request for vehicle 138 by selecting inspection button 406. This may bring up an editable inspection request template that may be used to compete an inspection request. A created inspection request may be added to a “current jobs” list viewable by one or more service providing users 102 via the user interface on computing device 104. Each department/vendor may have its own unique list of current jobs to view, along with a status for each job. Selecting a job from the list may allow service providing user 102 to view an “inspection page” for the job, which may comprise a questionnaire/form to be filled out by service providing user 102 at the end of a properly completed inspection of vehicle 138. Information from the inspection questionnaire/form may be used by system 100 to generate, either autonomously or semi-autonomously, an “estimate page” providing an estimated reconditioning cost and related information that may be reviewed, completed, modified and/or approved by one or more managing users 102. Managing users 102 may view a list of estimates waiting to be reviewed via the user interface displayed by computing device 104.

Screen 402 may further allow user 102 to select additional services that are desired to be performed on vehicle 138 by selecting one of buttons 308 (labeled only as button 408a in FIG. 3, for clarity).

Additionally during step 204, user 102, particularly a managing user 102, may use screen 404 to scan the VIN number for vehicle 138 or enter vehicle identification information manually using button 410 or 412, respectively. Vehicle identification information may include the last six digits of the VIN number, a stock number, and the like. Screen 404 may also give user 102 the option to capture one or more photographs of vehicle 138 using a camera associated with computing device 104 and upload them into system 100. Photographs may be displayed in grayscale for printing. A link to photographs of vehicle 138 may be provided by the user interface of computing device 104.

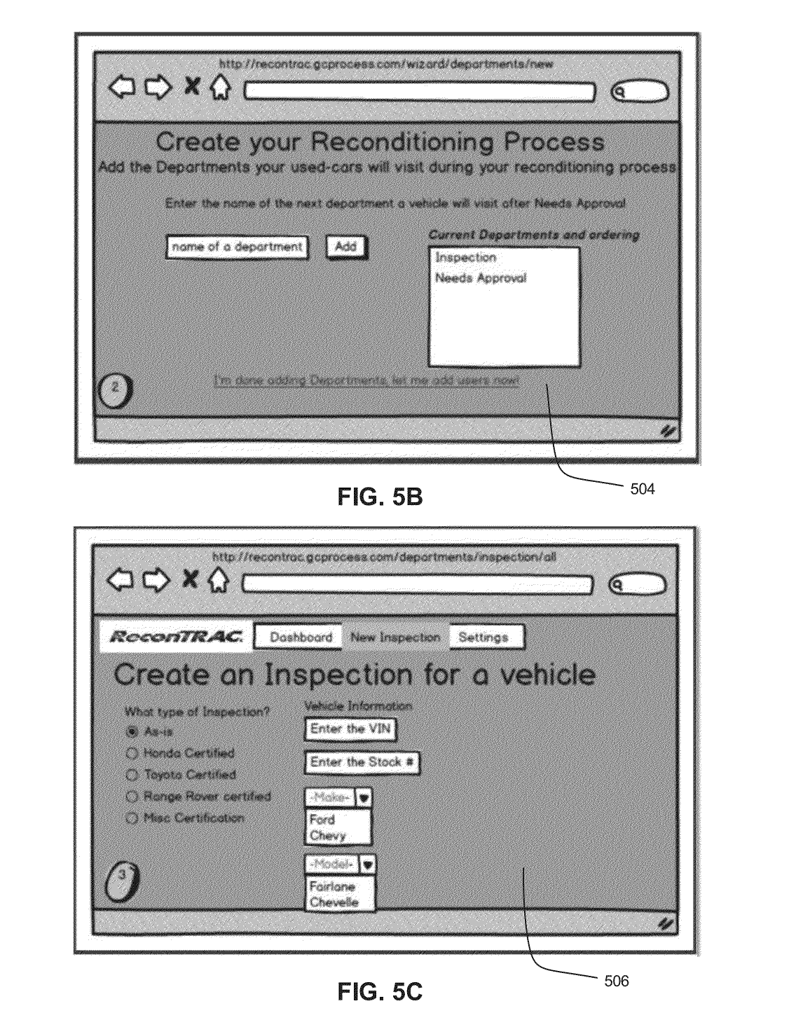

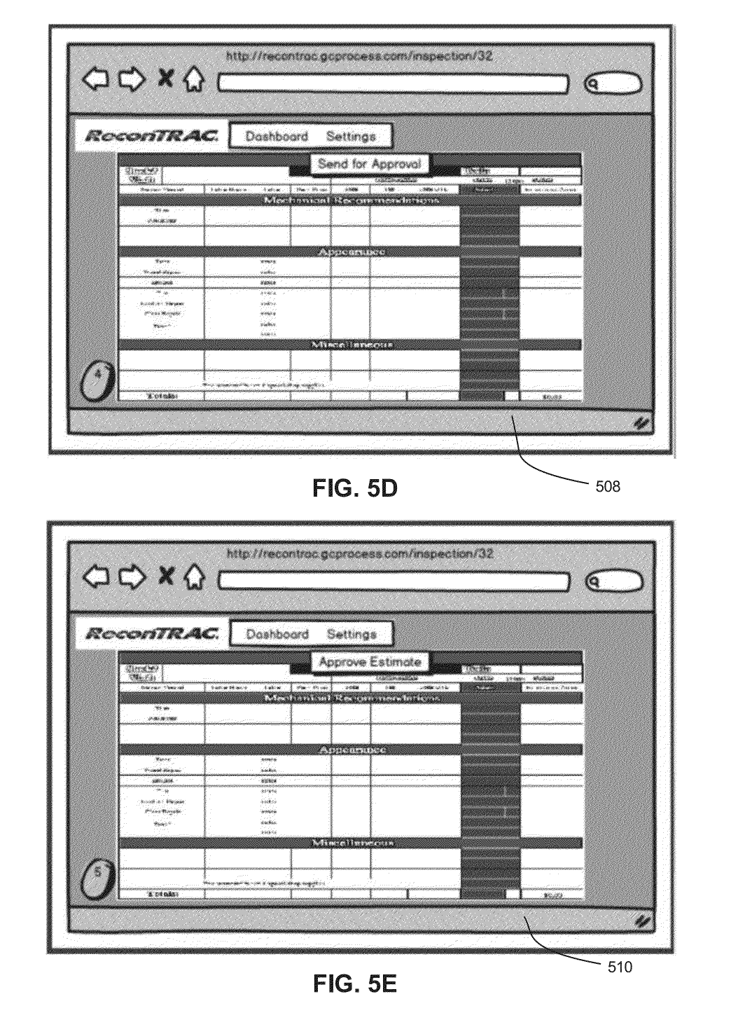

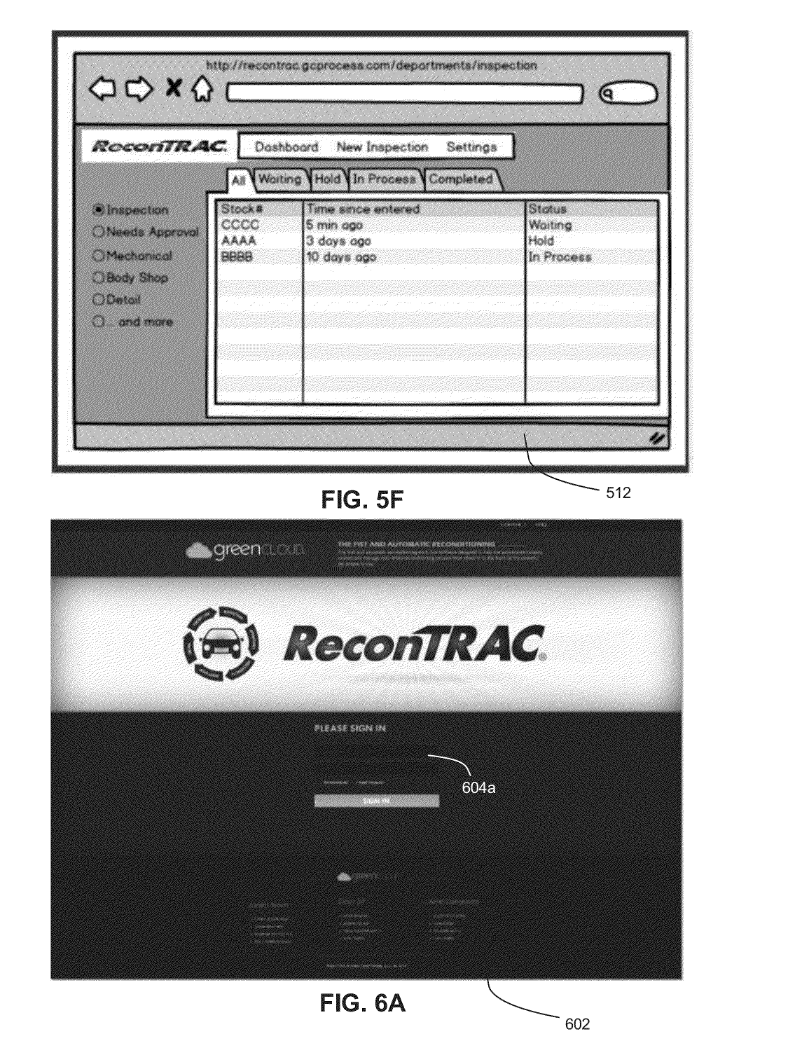

Referring now to FIGS. 5A-5F, screenshots which collectively illustrate exemplary processes, systems, and computer program products for managing a vehicle reconditioning process 200 using at least one computing device 104, according to an aspect of the present disclosure, are shown.

Screen 502 may be presented to user 102 via the user interface integrated with computing device 104 for the purpose of creating a user account within system 100. A user account may comprise information such as the full name of user 102, an email address, a password, a phone number, name of associated entity (e.g., a dealership), and similar information as may become apparent to those skilled in the relevant art(s) after reading the description herein. The information provided by user 102 to create a user account may be stored in user database 118 within system 100.

Screen 504 may be presented to user 102, particularly a managing user 102, during step 204 in order to create a reconditioning process 200. While creating reconditioning process 200, user 102 may select the various departments/vendors that vehicle 138 may need to visit, as well as the order in which those departments/vendors will be visited in order to properly complete reconditioning process 200.

Screen 506 may be presented to user 102, particularly a managing user 102, either prior to or during step 204, for the purpose of creating a vehicle inspection request in order to generate a sales estimate for vehicle 138 and/or an estimate of the cost of the reconditioning process for vehicle 138. User 102 may input identification information for vehicle 138 to be inspected, such as the VIN number and/or stock number. The make and model of vehicle 138 may be entered by user 102 or may be automatically generated by system 100 based on the vehicle identification information received. Additionally, user 102 may specify what type of estimate inspection is desired to be performed on vehicle 138 (e.g. “as-is,” “misc. certification,” and the like).

Screen 508 may be presented to user 102, particularly a service providing user 102, for the purpose of generating an estimate for the cost of reconditioning process 200 for vehicle 138. Service providing user 102 may fill out the form provided by screen 508 by inputting information about vehicle 138 and the work that needs to be done to recondition it, as well as the costs associated with the work.

Screen 510 may be presented to user 102, particularly a managing user 102, to allow managing user 102 to view the work that needs to be done to vehicle 102 and the costs associated with doing the work as determined by service providing user 102. Managing user 102 may use screen 510 to approve or decline the estimated work proposal and cost. An approved work proposal may cause system 100 to automatically generate a repair order that will travel with vehicle 138 from one department/vendor to another, digitally. The repair order may be automatically sent by system 100 to the first department/vendor listed in reconditioning process 200 as defined by managing user 102.

Screen 512 may be presented to any user 102 for the purpose of viewing the status of any vehicle 138 within system 100. Vehicles 138 may be viewed based on their association with various groupings, such as, by way of example and not limitation, which vehicles 138 are being inspected, which vehicles 138 are currently in the body shop, which vehicles 138 are awaiting job approval, and similar categories as will be apparent to those skilled in the relevant art(s) after reading the description herein. Additionally, each vehicle 138 may be displayed with status information in a list-style format that may include the length of time vehicle 138 has been in its current stage (e.g., how long it's been at the body shop) and/or how long it has been in reconditioning process 200, totally. Status information labels displayable for vehicle 138 may include but are not limited to “waiting,” “hold,” “in process,” and the like. Similar information may also be shown by screen 610 (not shown in FIGS. 5A-5F).

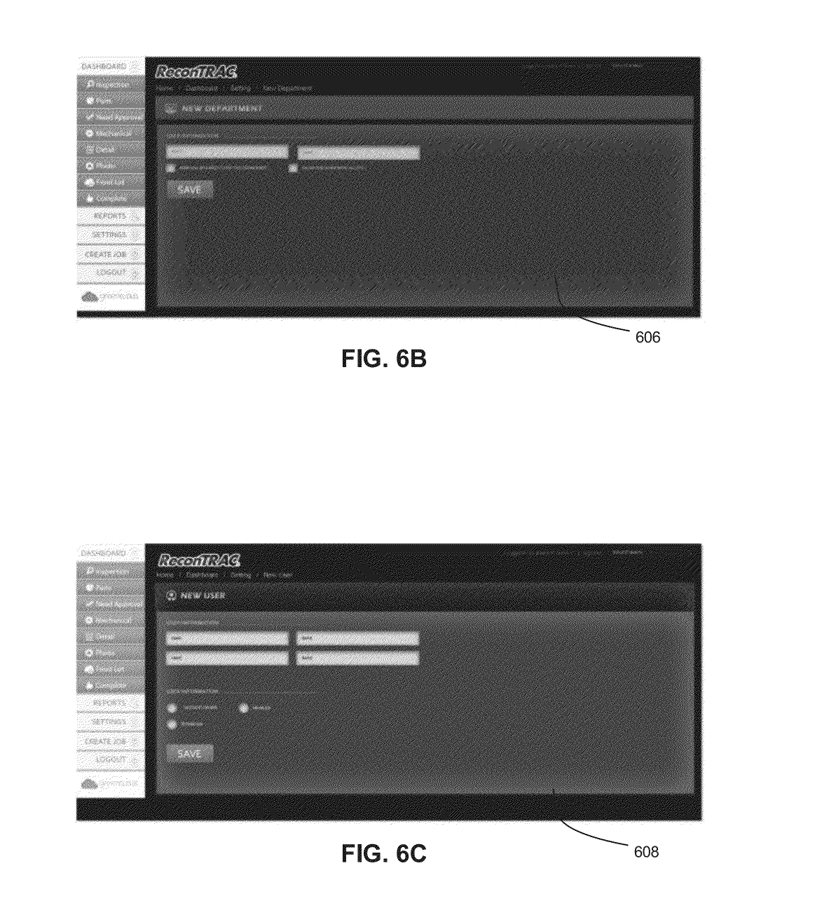

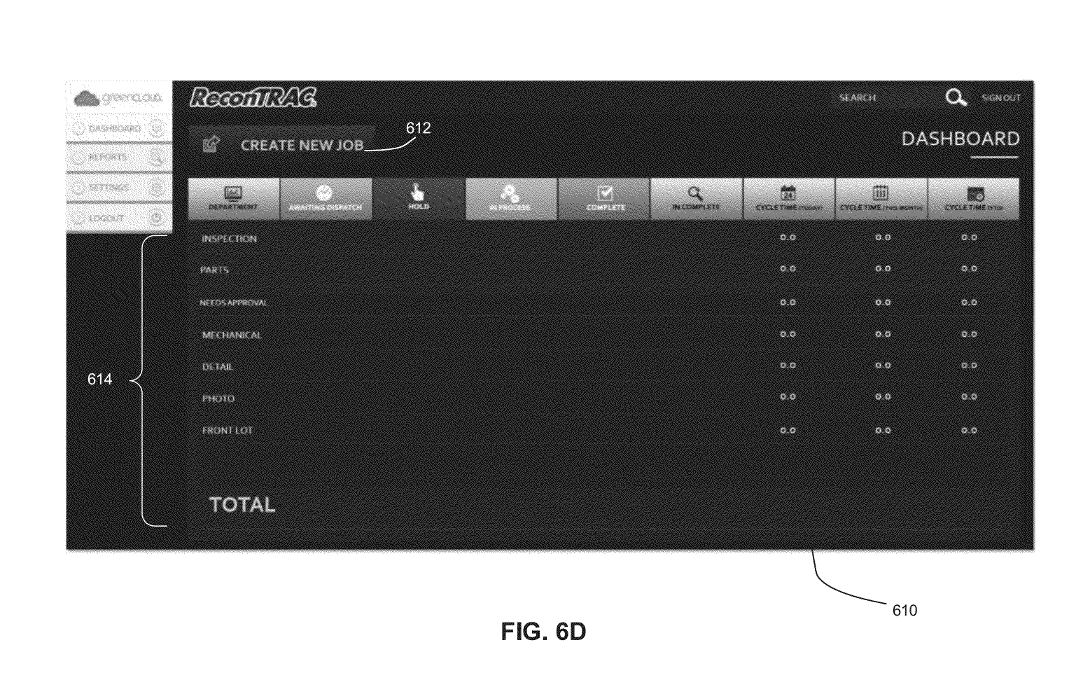

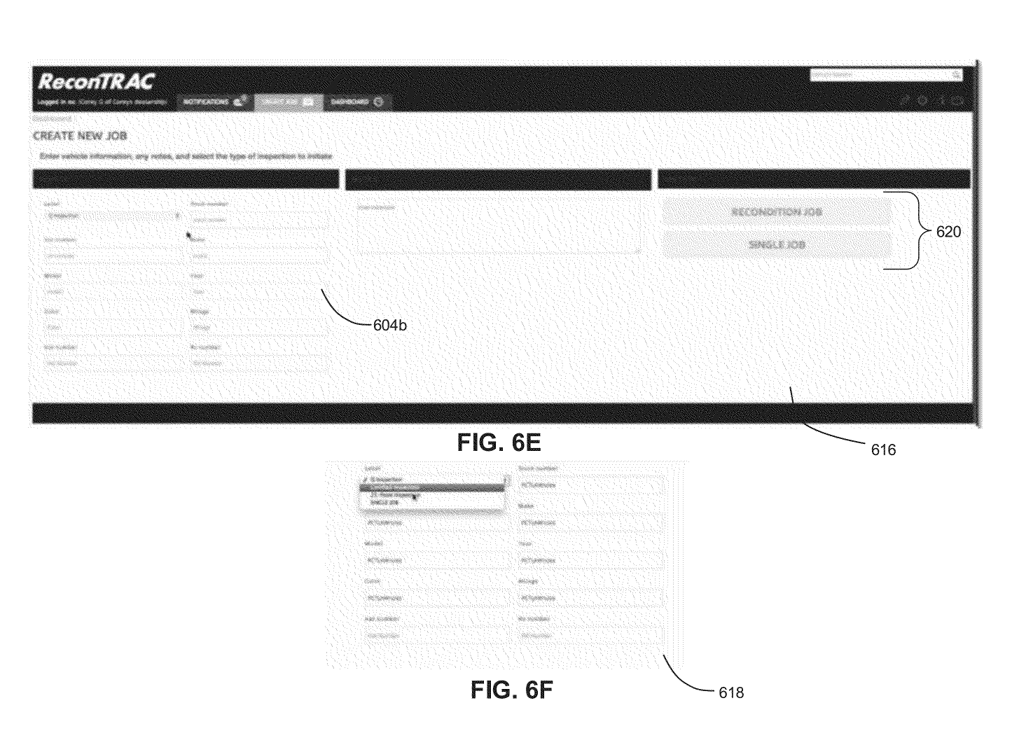

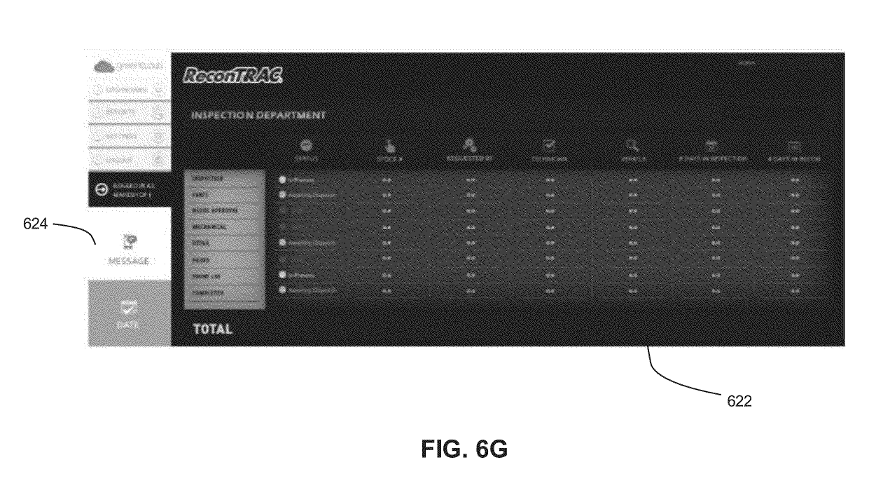

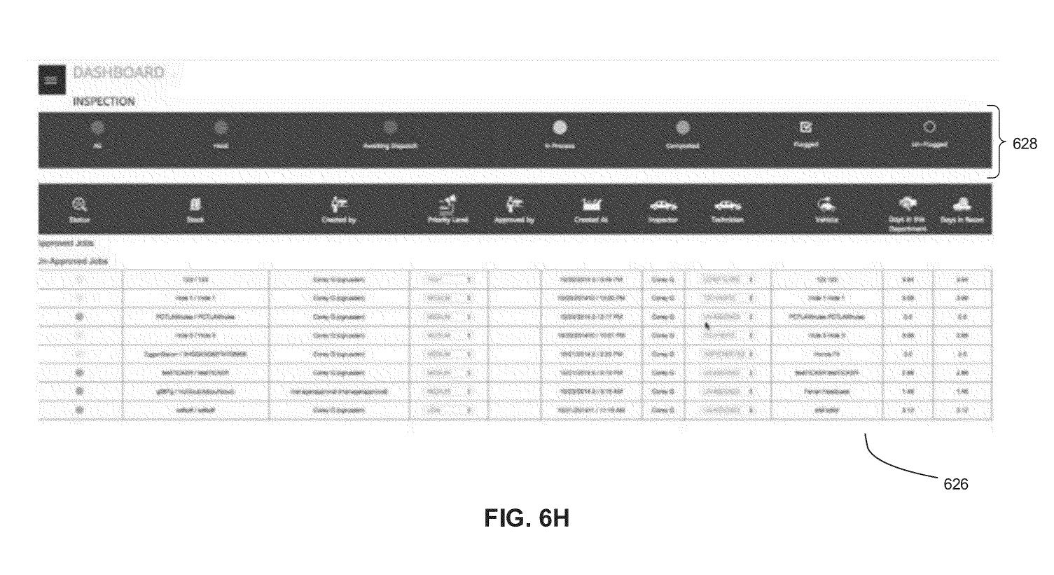

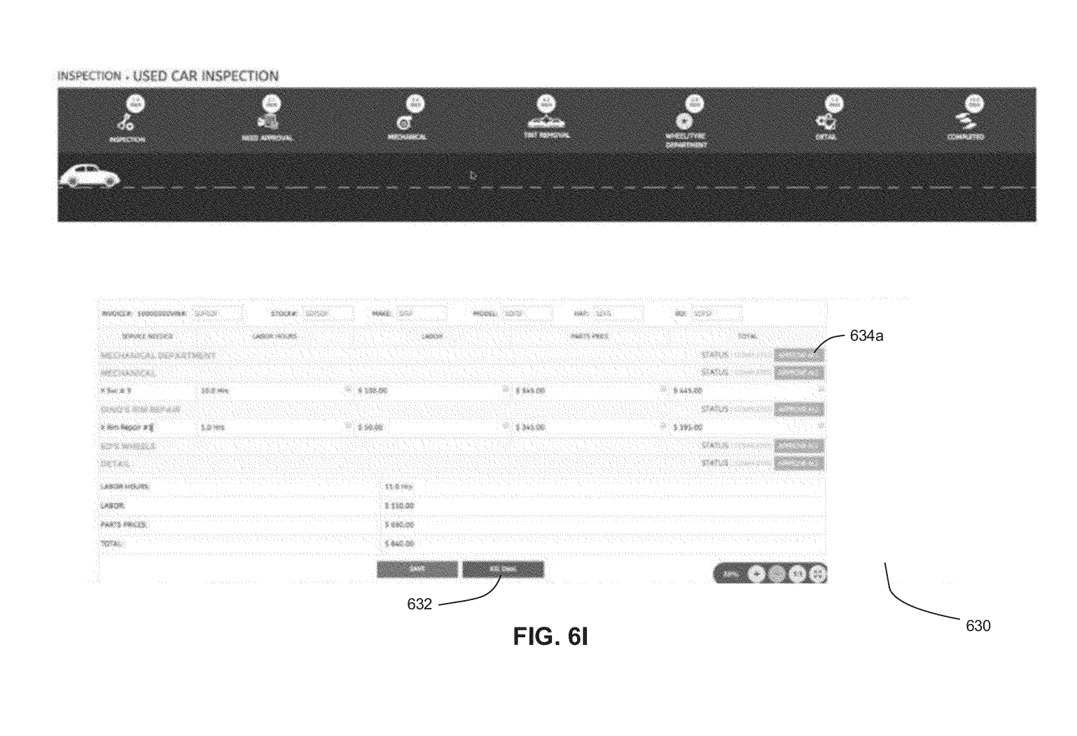

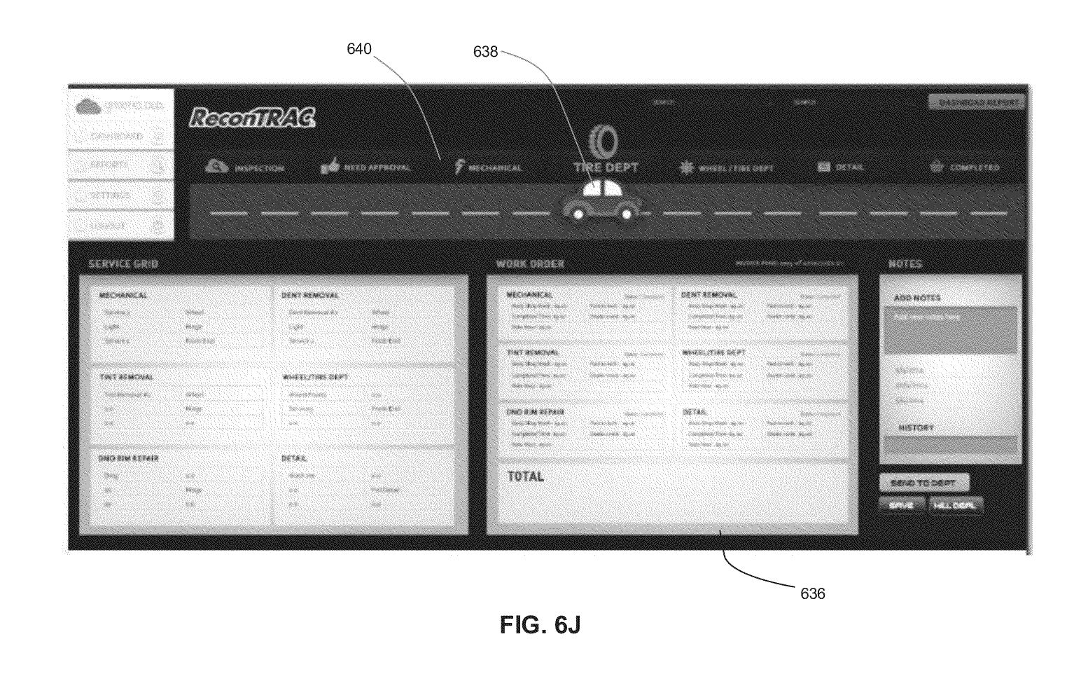

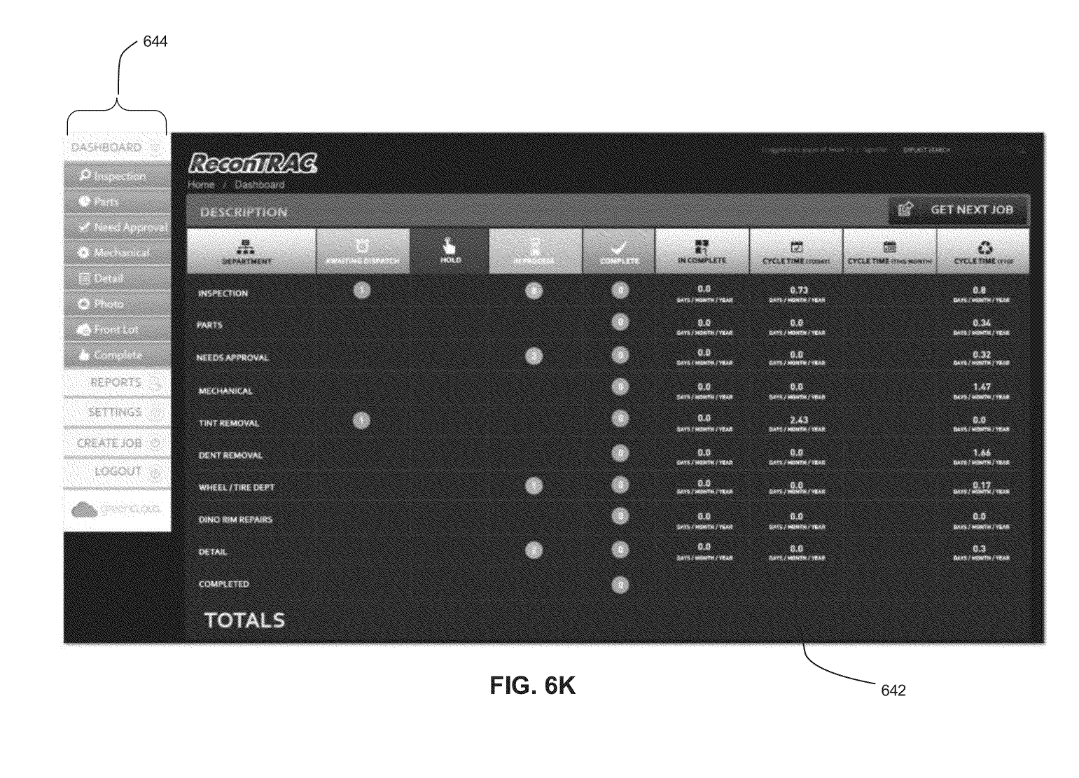

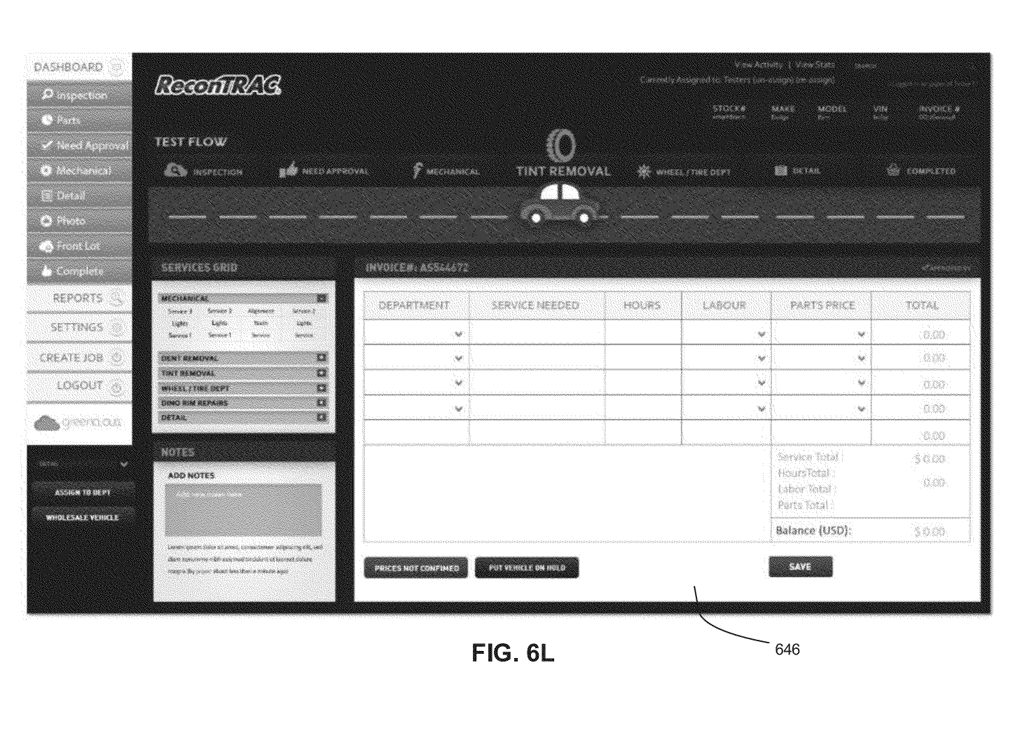

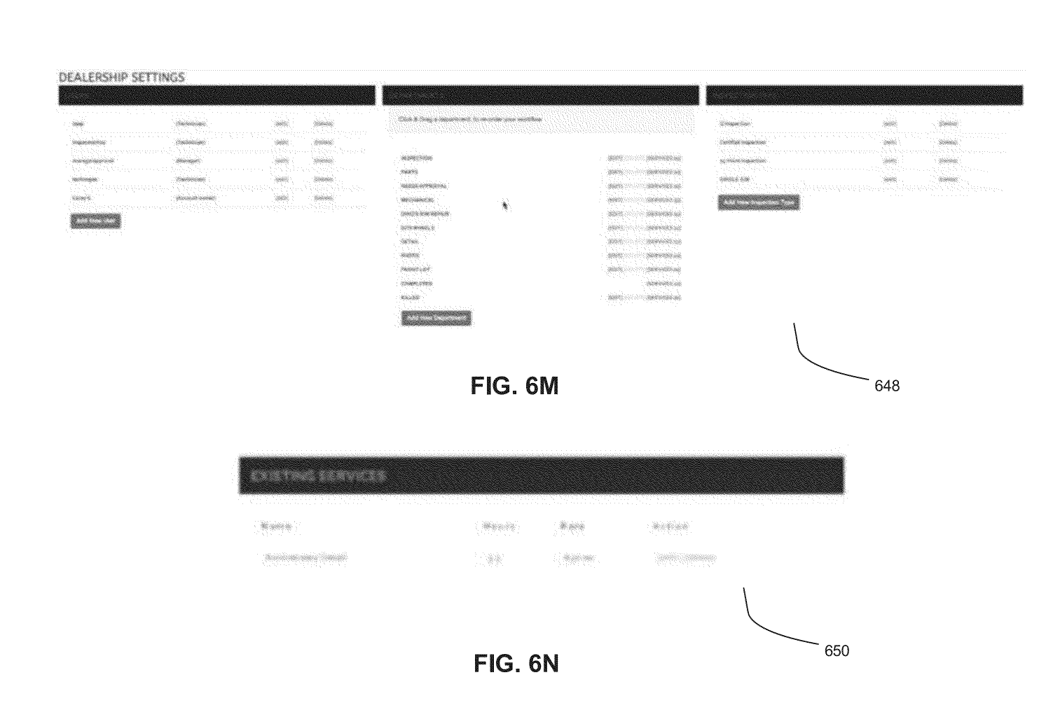

Referring now to FIGS. 6A-6N, screenshots which collectively illustrate additional exemplary processes, systems, and computer program products for managing a vehicle reconditioning process 200 using at least one computing device 104, according to an aspect of the present disclosure, are shown.

Screen 602 may be presented to any user 102 upon initially gaining access to system 100 for the purposes of signing in. Signing in to system 100 may require the submittal of identification information, such as, by way of example and not limitation, providing a username and password as may be stored with an associated user account within user database 118. Such identification information may be entered into fields 604 (labeled only as 604a in FIG. 6A, for clarity).

Screen 606 may be presented to user 102, particularly a managing user 102, in order to establish a department and/or vendor to be associated with a given entity, such as a dealership. By integrating a plethora of departments and/or vendors with system 100, services may be easily and quickly delegated as needed, depending on what type of work needs to be done. Additionally, the services performed by the various integrated departments/vendors may be easily tracked and monitored. Likewise, the various departments/vendors may have an efficient way to view the work that has been assigned to, is in progress, and has been completed by them.

Screen 608 may be presented to either a new user 102 or a current user 102 working on behalf of a new user 102 in order to create a new user account within system 100. Information that may be input for new users 102 may include a categorization as either technicians, managers, or account owners. Each user 102 that is added to system 100 may be assigned a username, password, email address, and the like, all of which may be stored within user database 118. Users 102 that are given manager status may have the ability to indicate, within system 100, which department(s)/vendor(s) they will oversee, and will accordingly receive notifications when jobs enter/are assigned to those department(s)/vendor(s). In a similar fashion, users 102 that are given technician status may be able to indicate, within system 100, which department(s)/vendor(s) they are associated with, thereby configuring system 100 to only display information relating to those department(s)/vendor(s) to those particular users 102 upon login. Other information relating to users 102 may be input via screen 608 as may be apparent to those skilled in the relevant art(s) after reading the description herein.

Screens 610 and 616 may be presented to user 102, particularly a managing user 102, at, by way of example and not limitation, step 204, for the purpose of creating a new service job request and/or reconditioning process 200. Each new service job may be created for specific departments/vendors and/or specific service providing users 102 working for such departments/vendors. More particularly, screen 610 may be presented to user 102 to serve as a dashboard, showing the current status of one or more (or all) vehicles 138 within system 100. Such status information may be presented within display area 614. Screen 610 may additionally include a link, button, or the like, such as button 612, that when selected, functions to direct user 102 to screen 616, at which a new job for vehicle 138 may be created. At screen 616, various types of information may be input into fields 604 (labeled only as 604b in FIG. 6E, for clarity) regarding vehicle 138 and the work to be performed on it, including, but not limited to, the VIN number, stock number, make, model, year, mileage, color, vehicle 138 notes, and the like. Some or all of fields 604 may comprise one or more choices from which user 102 may select, presented in the form of a drop-down menu or similar configuration. In some aspects, upon entering the stock number or a portion thereof for vehicle 138, many or all of the other fields 604 may be automatically filled by system 100, as such information may be integrated with the stock number. In some other aspects, data for some or all of fields 604 may be manually entered and/or derived upon the input of all or part of the VIN number for vehicle 138. Screen 616 may also provide links, buttons, or similar means, such as buttons 620, via which user 102 may select whether to perform an entire reconditioning process 200 on vehicle 138 or a single, specific job. By way of example and not limitation, a single job may comprise a complete detailing of vehicle 138. When a single job is selected, the job information and vehicle 138 information may be sent to the relevant department/vendor only, and no calculation for total reconditioning process 200 time, or “cycle time,” will be generated, as reconditioning process 200 will not take place with regard to that vehicle 138.

Screen 618 may be presented to any user 102 designating one or more services to be performed on vehicle 138. Services may be indicated based on type, such as, by way of example and not limitation, mechanical services, electrical services, and the like. Service information may include, but is not limited to, the name of the service, the dealer labor rate for the service, the amount of labor hours required for the service, as well as other similar information at may be apparent to those skilled in the relevant art(s) after reading the description herein. Screen 618 may additionally include a list of existing services that have been assigned to vehicle 138.

Screens 622 and/or 626 may be presented to any user 102 for the purpose of viewing and/or modifying a list of all of the current/approved service jobs relating to vehicle 138 assigned to a specific department/vendor and/or specific service providing user 102 employed thereby. In a sense, screen 622/626 function as virtual “buckets” of jobs for each department/vendor and/or service providing user 102 within system 100. A service job within the list may contain the status of the service being provided on vehicle 138, such as, by way of example and not limitation, a word description or status code, representative of a status selected from status code bar 628. Service job information within the list may further include a stock number identifying vehicle 138, the amount of time vehicle 138 has been in possession of a given department/vendor, the amount of time vehicle 138 has spent in reconditioning process 200, an identification of a job creating user 102, a priority level, an identification of a user 102 job approver, a job creation date and time, an identification of an inspecting user 102, a technician selection for the job, a vehicle 138 identification, as well as similar information as will be apparent to those skilled in the relevant art(s) after reading the description herein. Additionally, screen 622/626, as well as any other screen generated by system 100, may contain message selector 624, which may be in the form of a button, link, or similar representation as recognized by those skilled in the relevant art(s). Message selector 624 may be used to enable text-based messaging and/or voice messaging amongst various users 102 of system 100 via computing devices 104. In some aspects, screens 622/626 may contain separate lists for vehicles 138 that have been approved for jobs and vehicles 138 that are waiting for approval. Various statuses that may be indicated for vehicles 138 displayed on screen 622/626 may include, but are not limited to, “awaiting dispatch,” “in process,” “on hold,” “completed,” and the like.

Screen 630 may be presented to any user 102 at any time in order receive and display information relating to one or more inspection reports for vehicle 138. More specifically, one or more departments/vendors may inspect vehicle 138, and then input information regarding the inspection and any work that is deemed to be necessary as part of vehicle reconditioning process 200. Each department/vendor may be able to view the inspection reports/work proposals entered by other departments/vendors. All entries may also be viewable by managing user 102. Managing user 102 may have the ability to approve one or more process 200 projects to be performed on vehicle 138, such as by selecting an approval button 634 (labeled only as 634a in FIG. 61, for clarity). Similarly, managing user 102 may edit any of the work proposals and send them back to the relevant department/vendor for acceptance. By way of example and not limitation, a department/vendor may propose that vehicle 138 needs body work done, and that the cost associated with the body work will be $800.00. Managing user 102 may only be willing to spend $600.00 on the body work and/or only want certain portions of the body work completed. Therefore, managing user 102 may adjust the price to $600.00 and request an indication of how much body work could be done for that amount; or, managing user 102 may specify which portions of the work should be completed and request an updated cost for completing the selected portions. If it is determined that one or more elements of reconditioning process 200 cannot be performed for an agreeable amount, or that reconditioning process 200 cannot be completed with a cost that allows it to place vehicle 138 in a position to make a certain profit on resale, or for any other reason at any time, managing user 102 may cancel reconditioning process 200 or one or more processes associated therewith by pressing “Kill Deal” button 632, or by making a similar cancellation request. Button 632 may be displayable on various other screens presented by system 100 on computing device 104.

Screen 636 may be presented to any user 102 for the purpose of viewing one or more work orders related to vehicle 138. Details regarding various service jobs as related to specific departments/vendors may be displayed within screen 636. Such details may be entered/modified/saved by a managing user 102 or any user 102 with appropriate permission, and may include type of work to be done as well as the cost associated with the work. The work order may be viewable by service providing users 102 so they know what services to perform on vehicle 138. All service jobs pertaining to vehicle 138 relating to reconditioning process 200 may also be displayed via screen 636. Additionally, screen 636 may comprise a graphic 638, such as the illustration of a car, to visually represent vehicle 138. In some aspects, graphic 638 comprises an actual photograph of vehicle 138. Graphic 638 may be movable relative to a department/vendor label within toolbar 640, either autonomously by system 100 or by user 102 via the user interface within computing device 104, in order to represent the current, past, or future location of vehicle 138. The work order information relating to the department/vendor within toolbar 640 that is matched by graphic 638 may be displayed in the main portion of screen 636 and is therefore adjustable via the movement of graphic 638.

Screen 642 may be presented to any user 102 at any time for the purpose of showing a description of the specific reconditioning process 200 being applied to vehicle 138. The description may comprise various aspects, such as the departments that will be utilized during process 200, times involved in completing process 200 and the components thereof, and completion status information regarding process 200 and any of its components (e.g. “complete,” “in process,” “hold,” etc.).

Screen 646 may be presented to any user 102 at any time for the purpose of depicting and/or creating invoice and/or work order details about the reconditioning process 200 to be performed/having been performed upon vehicle 138. Specifically, screen 646 may display such invoice/work order information as which various departments/vendors may perform/have performed work on vehicle 138, what services those departments/vendors may perform/did perform, how long those services will take/took, how much the labor and parts will cost/did cost, a total price calculated for each desired service, a total price for the entire reconditioning process 200, and the like. Users 102 with the appropriate authorization, particularly managing users 102, may edit the information displayed on screen 646 via the user interface on computing device 104, as well as cancel or pause any service/process that has not been completed yet.

Screen 648 may be presented to any user 102 at any time for the purpose of displaying one or more dealership settings. Managing users 102 may be particularly concerned with viewing the content of screen 648, and may also have the primary ability to edit such content. In an aspect, dealership settings may comprise a list of users 102 associated with the dealership, a list of departments/vendors associated with the dealership, a list of the types of inspections/headings for jobs that may be performed by the dealership, and similar information as may be apparent to those skilled in the relevant art(s) after reading the description herein. Content within screen 648 may be added, deleted, and/or edited by managing user 102, or a user 102 with similar authority within system 100. With regard to the list of departments/vendors, the order of the list may, in some aspects, indicate the order in which vehicle 138 may pass through the various departments/vendors that make up reconditioning process 200. The order may be altered by rearranging the departments/vendors in the list. Barring an override or alternative order input into system 100, the listed order would be the order followed by system 100 in aspects wherein system 100 autonomously dictates where vehicle 138 should go. Each department/vendor within the list may contain its own variety of customizable services/jobs and associated values for such services/jobs. Additionally, the department/vendor list may include information regarding the services and associated costs that may be performed by each department/vendor.

Screen 648 may additionally display an inventory feed of all the new and/or used vehicles 138 at the dealership. Such a feed may allow users 102 to create jobs for vehicles 138 electronically via system 100.

Screen 650 may be presented to any user 102 at any time, either as a portion of screen 648 or as a separate screen within computing device 104, for the purpose of indicating the existing services that have been/are being/will be performed on vehicle 138. Each existing service entry may include a service name, time required, cost rate, action, and similar information as may be apparent to those skilled in the relevant art(s) after reading the description herein.

Screens 606-650 and similar screens may be presented on computing device 104 with an ever-present menu 644 docked, either permanently or moveably, to a certain part of the display screen, such as the left hand side. Menu 644 and its associated submenus may include a variety of buttons that take user 102 directly to various displays and/or functions of system 100, including a list of completed services, a list of items awaiting approval, photos for various vehicles 138, and similar items as will be apparent to those skilled in the relevant art(s) after reading the description herein.

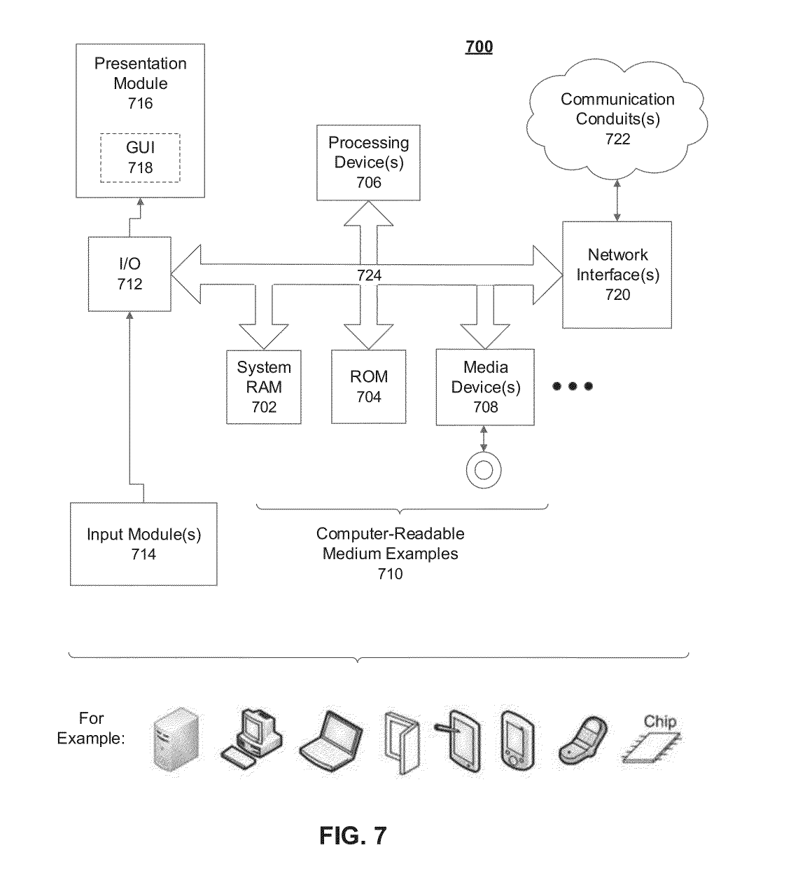

Referring now to FIG. 7, a block diagram of an exemplary computer system useful for implementing various aspects the processes disclosed herein, in accordance with one or more aspects of the present disclosure, is shown

That is, FIG. 7 sets forth illustrative computing functionality 700 that may be used to implement web server 108, one or more gateways 120-130, vehicle database 112, VIN database 114, scan database 116, user database 118, computing devices 104 utilized by users 102 to access Internet 106, or any other component of system 100. In all cases, computing functionality 700 represents one or more physical and tangible processing mechanisms.

Computing functionality 700 may comprise volatile and non-volatile memory, such as RAM 702 and ROM 704, as well as one or more processing devices 706 (e.g., one or more central processing units (CPUs), one or more graphical processing units (GPUs), and the like). Computing functionality 700 also optionally comprises various media devices 708, such as a hard disk module, an optical disk module, and so forth. Computing functionality 700 may perform various operations identified above when the processing device(s) 706 execute(s) instructions that are maintained by memory (e.g., RAM 702, ROM 704, and the like).

More generally, instructions and other information may be stored on any computer readable medium 710, including, but not limited to, static memory storage devices, magnetic storage devices, and optical storage devices. The term “computer readable medium” also encompasses plural storage devices. In all cases, computer readable medium 710 represents some form of physical and tangible entity. By way of example, and not limitation, computer readable medium 710 may comprise “computer storage media” and “communications media.”

“Computer storage media” comprises volatile and non-volatile, removable and non-removable media implemented in any method or technology for storage of information, such as computer readable instructions, data structures, program modules, or other data. Computer storage media may be, for example, and not limitation, RAM 702, ROM 704, EEPROM, Flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 700 may also comprise an input/output module 712 for receiving various inputs (via input modules 714), and for providing various outputs (via one or more output modules). One particular output module mechanism may be a presentation module 716 and an associated GUI 718. Computing functionality 700 may also include one or more network interfaces 720 for exchanging data with other devices via one or more communication conduits 722. In some embodiments, one or more communication buses 724 communicatively couple the above-described components together.

Communication conduit(s) 722 may be implemented in any manner (e.g., by a local area network, a wide area network (e.g., the Internet), and the like, or any combination thereof). Communication conduit(s) 722 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “module” and “component” as used herein generally represent software, firmware, hardware, or combinations thereof. In the case of a software implementation, the module or component represents program code that performs specified tasks when executed on a processor. The program code may be stored in one or more computer readable memory devices. The features of the present disclosure described herein are platform-independent, meaning that the techniques can be implemented on a variety of commercial computing platforms having a variety of processors (e.g., set-top box, desktop, laptop, notebook, tablet computer, personal digital assistant (PDA), mobile telephone, smart telephone, gaming console, and the like).

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein). As will be appreciated by those skilled in the relevant art(s) after reading the description herein, certain features from different aspects of the systems, methods and computer program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A computer-implemented method for facilitating an online task management system for reconditioning vehicles, comprising the steps of:
(a) receiving, via a computing device at a vehicle dealership, at least one vehicle work flow order specification for at least one vehicle;
(b) storing the at least one vehicle work flow order specification for the at least one vehicle;
(c) determining a work flow order for the at least one vehicle, the work flow order based at least partially on the received at least one vehicle work flow order specification, wherein the work flow order comprises a work order that further comprises at least one service to be performed on the at least one vehicle; and
(d) displaying, via an associated computing device, the work flow order for the at least one vehicle to one of: at least one vehicle work order service provider and at least one vehicle work order manager.

2. The method of claim 1, wherein the at least one vehicle work flow order specification is at least one of: a chronological work flow order preference and a sequential work flow order preference based at least partially on a work order service type.

3. The method of claim 1, further comprising the step of:
(e) receiving at least one evaluation for the at least one vehicle, the at least one evaluation based on at least one of: a physical aspect and a mechanical aspect of the at least one vehicle.

4. The method of claim 1, further comprising the step of:
(e) generating an invoice for the at least one service performed on the at least one vehicle.

5. The method of claim 1, further comprising the step of:
(e) displaying an indication to a user of at least one status of the at least one vehicle.

6. The method of claim 5, wherein the at least one status is one of: a current location for the at least one vehicle; the at least one service currently being performed on the at least one vehicle; an amount of time the at least one vehicle has spent in its current location; and an amount of time the at least one vehicle has spent receiving the at least one service currently being performed.

7. The method of claim 1, further comprising the step of:
(e) facilitating payment for at least one completed service performed on the at least one vehicle.

8. The method of claim 1, further comprising the step of:
(e) determining a depreciation value for the at least one vehicle.

9. The method of claim 8, wherein the depreciation value is based on a comparison between a current value of the at least one vehicle and a previous value of the at least one vehicle.

10. The method of claim 9, wherein the previous value of the at least one vehicle is the value of the at least one vehicle when it is initially appraised by a vehicle receiver.

11. The method of claim 10, wherein the vehicle receiver comprises a vehicle dealership.

12. One or more computer storage media having stored thereon multiple instructions that implement an online vehicle reconditioning task management portal component by, when executed by one or more processors of a computing device, causing the one or more processers to:
(a) receive at least one vehicle work flow order specification for at least one vehicle;
(b) store the at least one vehicle work flow order specification for the at least one vehicle;
(c) determine a work flow order for the at least one vehicle, the work flow order based at least partially on the received at least one vehicle work flow order specification, wherein the work flow order comprises a work flow that further comprises at least one service to be performed on the at least one vehicle; and
(d) display the work flow order for the at least one vehicle to one of: at least one vehicle work order service provider and at least one vehicle work order manager.

13. One or more computer storage media as recited in claim 12, wherein the at least one vehicle work flow order specification comprises at least one of: a chronological work flow order preference and a sequential work flow order preference based at least partially on a work order service type.

14. One or more computer storage media as recited in claim 12, wherein the multiple instructions further cause the one or more processors to:
(e) receive at least one evaluation for the at least one vehicle, the at least one evaluation based on at least one of: a physical aspect and a mechanical aspect of the at least one vehicle.

15. One or more computer storage media as recited in claim 12, wherein the multiple instructions further cause the one or more processors to:
(e) generate an invoice for the at least one service performed on the at least one vehicle.

16. One or more computer storage media as recited in claim 12, wherein the multiple instructions further cause the one or more processors to:
(e) display an indication to a user of at least one status of the at least one vehicle.

17. One or more computer storage media as recited in claim 16, wherein the at least one status comprises one of: a current location for the at least one vehicle; the at least one service currently being performed on the at least one vehicle; the amount of time the at least one vehicle has spent in its current location; and the amount of time the at least one vehicle has spent receiving the at least one service currently being performed.

18. One or more computer storage media as recited in claim 12, wherein the multiple instructions further cause the one or more processors to:
(e) facilitate payment for at least one completed service performed on the at least one vehicle.

19. One or more computer storage media as recited in claim 12, wherein the multiple instructions further cause the one or more processors to:
(e) determine a depreciation value for the at least one vehicle.

20. One or more computer storage media as recited in claim 19, wherein the depreciation value is based on a comparison between a current value of the at least one vehicle and a previous value of the at least one vehicle.

21. One or more computer storage media as recited in claim 20, wherein the previous value of the at least one vehicle is the value of the at least one vehicle when it is initially appraised by a vehicle receiver.

22. One or more computer storage media as recited in claim 21, wherein the vehicle receiver comprises a vehicle dealership.

23. A computer system for facilitating the operation of an online task management system for reconditioning vehicles, comprising:
(a) means for receiving, via a computing device at a vehicle dealership, at least one vehicle work flow order specification for at least one vehicle;
(b) means for storing the at least one vehicle work flow order specification for the at least one vehicle;
(c) means for determining a work flow order for the at least one vehicle, the work flow order based at least partially on the received at least one vehicle work flow order specification, wherein the work flow order comprises a work flow that further comprises at least one service to be performed on the at least one vehicle; and
(d) means for displaying, via an associated computing device, the work flow order for the at least one vehicle to one of: at least one vehicle work order service provider and at least one vehicle work order manager.

24. The computer system of claim 23, wherein the vehicle work flow order specification comprises at least one of: a chronological work flow order preference and a sequential work flow order preference based on a work order service type.

25. The computer system of claim 23, further comprising:
(e) means for receiving at least one evaluation for the at least one vehicle, the at least one evaluation based on at least one of: a physical aspect and a mechanical aspect of the at least one vehicle.

26. The computer system of claim 23, further comprising:
(e) means for generating an invoice for the at least one service performed on the at least one vehicle.

27. The computer system of claim 23, further comprising:
(e) means for displaying an indication to a user of at least one status of the at least one vehicle.

28. The computer system of claim 27, wherein the at least one status comprises one of: a current location for the at least one vehicle; the at least one service currently being performed on the at least one vehicle; the amount of time the at least one vehicle has spent in its current location; and the amount of time the at least one vehicle has spent receiving the at least one service currently being performed.

29. The computer system of claim 23, further comprising:
(e) means for facilitating payment for at least one completed service performed on the at least one vehicle.

30. The computer system of claim 23, further comprising:
(e) means for determining a depreciation value for the at least one vehicle.

31. The computer system of claim 30, wherein the depreciation value is based on a comparison between a current value of the at least one vehicle and a previous value of the at least one vehicle.

32. The computer system of claim 31, wherein the previous value of the at least one vehicle is the value of the at least one vehicle when it is initially appraised by a vehicle receiver.

33. The computer system of claim 32, wherein the vehicle receiver comprises a vehicle dealership.
